(19) United States
(12) Patent Application Publication
(10) Pub. No.: US 2023/0043317 A1
(43) Pub. Date: Feb. 9, 2023

(54) Sm-Fe-N MAGNET

(71) Applicants: Hirotaka YOKOTA, Tokyo (JP); Shusuke Okada, Aichi (JP); Kenta Takagi, Aichi (JP)

(72) Inventors: Hirotaka YOKOTA, Tokyo (JP); Shusuke Okada, Aichi (JP); Kenta Takagi, Aichi (JP)

(73) Assignees: TDK Corporation, Tokyo (JP); National Institute of Advanced Industrial Science and Technology, Tokyo (JP)

(21) Appl. No.: 17/815,331

(22) Filed: Jul. 27, 2022

(30) Foreign Application Priority Data
Jul. 29, 2021 (JP) 2021-124119

(51) Int. Cl. H01F 1/059; B22F 1/17; C22C 38/00

(52) U.S. Cl. CPC H01F 1/059; B22F 1/17; C22C 38/005; C22C 38/001; C22C 38/002; B22F 2301/355; C22C 2202/02

(57) ABSTRACT

A Sm—Fe—N magnet includes Sm—Fe—N particles each having a surface, a coating layer being provided on at least a portion of the surface or on at least a portion of an interface between at least two of the Sm—Fe—N particles, or being provided on both, wherein the coating layer includes a first layer and a second layer, the first layer being situated closer to the surface or the interface than is the second layer, he first layer includes α-Fe, the second layer includes a Sm—Fe—Zn alloy, and a Zn content contained in the second layer is 1 at % or more and 20 at % or less.

### CROSS-REFERENCE TO RELATED APPLICATIONS

The present application is based on and claims priority to Japanese Priority Application No. 2021-124119 filed on Jul. 29, 2021, the entire contents of which are hereby incorporated herein by reference.

### BACKGROUND

### Technical Field

The present disclosure relates to a Sm—Fe—N magnet.

### Description of Related Art

The Sm—Fe—N magnet is expected to be a high-performance magnet because of its high Curie temperature of 477 degrees Celsius, its small temperature variation in magnetic properties, and its high anisotropic magnetic field of 20.6 MA/m, which is the theoretical limit of coercivity.

International Publication No. 2017/150557 discloses a method for producing a fine Sm—Fe—N powder including a reduction-diffusion process of a precursor powder of a Sm—Fe alloy to produce an alloy powder and a nitriding process.

In order to manufacture a high-performance magnet from a magnetic powder having a high coercivity, it is necessary to sinter the Sm—Fe—N powder.

However, when the Sm—Fe—N powder is sintered at a high temperature, there is a problem in that the magnetic properties deteriorate. In particular, the coercivity of the Sm—Fe—N magnet gets greatly reduced by the sintering process.

Furthermore, International Publication No. 2019/189440 proposes that the surface of the Sm—Fe—N powder is coated with a sub-phase containing a metal such as zirconium, thereby suppressing a reduction in the coercivity of the magnet obtained by sintering.

### SUMMARY

According to the experiments conducted by the inventors of the present application, even with the methods described in International Publication No. 2017/150557 and International Publication No. 2019/189440, the coercivity of the Sm—Fe—N magnet manufactured is still lower than that of the powder, and the conventional countermeasures cannot be said to be sufficient.

Accordingly, more effective countermeasures capable of reducing a reduction in the coercivity of the Sm—Fe—N magnet are desired.

In view of such background, it is desired to provide a Sm—Fe—N magnet having a high coercivity comparable to the coercivity of Sm—Fe—N-powder.

An embodiment of the present disclosure provides a Sm—Fe—N magnet including:

Sm—Fe—N particles each having a surface, a coating layer being provided on at least a portion of the surface or on at least a portion of an interface between at least two of the Sm—Fe—N particles, or being provided on both,

wherein the coating layer includes a first layer and a second layer, the first layer being situated closer to the surface or the interface than is the second layer,

the first layer includes α-Fe,

the second layer includes a Sm—Fe—Zn alloy, and

a Zn content contained in the second layer is 1 at % or more and 20 at % or less.

### BRIEF DESCRIPTION OF THE DRAWINGS

FIG. 1 is a drawing schematically illustrating an example of configuration of a cross section of Sm—Fe—N particle included in a Sm—Fe—N magnet according to an embodiment of the present disclosure.

FIG. 2 is a drawing schematically illustrating an example of a flow of a method for producing the Sm—Fe—N magnet according to the embodiment of the present disclosure.

FIG. 3 is a drawing schematically illustrating an example of a flow of a method for producing Sm—Fe—N magnet powder in a method for producing the Sm—Fe—N magnet according to the embodiment of the present disclosure.

FIG. 4 is a drawing illustrating a mapping result of each element obtained by HAADF-STEM (High-angle Annular Dark Field Scanning Transmission Electron Microscopy) and EDS (Energy Dispersive X-ray Spectrometry) in a cross section of the Sm—Fe—N magnet according to the embodiment of the present disclosure.

FIG. 5 is a drawing illustrating a TEM image (bright-field image) of an enlarged portion of an interface between Sm—Fe—N particles of the Sm—Fe—N magnet according to the embodiment of the present disclosure.

FIG. 6 is a drawing illustrating a mapping result of Fe and Zn obtained by EDS of an enlarged portion of an interface between Sm—Fe—N particles of the Sm—Fe—N magnet according to the embodiment of the present disclosure.

FIG. 7 is a drawing illustrating an electron diffraction image of an Fe-rich layer in an enlarged portion of an interface between Sm—Fe—N particles of the Sm—Fe—N magnet according to the embodiment of the present disclosure.

FIG. 8 is a drawing illustrating an example of an EDS line analysis result of an interface between Sm—Fe—N particles according to the Sm—Fe—N magnet according to the embodiment of the present disclosure.

### DETAILED DESCRIPTION

Hereinafter, an embodiment of the present disclosure is explained.

In the embodiment of the present disclosure,

a Sm—Fe—N magnet includes:

Sm—Fe—N particles each having a surface, a coating layer being provided on at least a portion of the surface or on at least a portion of an interface between at least two of the Sm—Fe—N particles, or being provided on both,

wherein the coating layer includes a first layer and a second layer, the first layer being situated closer to the surface or the interface than is the second layer,

the first layer includes aαFe,

the second layer includes a Sm—Fe—Zn alloy, and

a Zn content contained in the second layer is 1 at % or more and 20 at % or less.

In this case, in the present application, a “surface” of any given particle included in a magnet means a surface of the particle excluding an interface bonded to another particle, i.e., means an “exposed surface”.

In the present application, a term “layer” means a coating covering an object, wherein a ratio (t/L) of a maximum dimension t in a normal direction (i.e., thickness direction) to a coating length L in a cross-sectional view is less than 1. Thus, the “layer” includes not only an “entire coating layer” covering the entire surface of a particle but also an “intermittent layer” covering the surface of the particle intermittently, and a “local layer” covering only a portion of the surface of the particle. However, even in the “local layer”, the coating length L is 50 nm or more.

As described above, when the Sm—Fe—N powder is sintered at a high temperature, there is a problem in that the magnetic properties deteriorate. In particular, the coercivity of the Sm—Fe—N magnet is greatly reduced by the sintering process.

In contrast, in the embodiment of the present disclosure, a coating layer having a first layer and a second layer is formed on at least a portion of the surface of a Sm—Fe—N particle included in a magnet and/or an interface between Sm—Fe—N particles. The first layer has α-Fe and the second layer has Sm—Fe—Zn alloy.

With such a configuration, in the embodiment of the present disclosure, a Sm—Fe—N magnet having a high coercivity comparable to the coercivity of Sm—Fe—N-powder can be provided.

It should be noted that, at present, the reason why a reduction in the coercivity can be alleviated by the configuration of the magnet according to the embodiment of the present disclosure is not clearly known.

However, the following mechanism can be assumed.

Generally, when the Sm—Fe—N particles are heat-treated, there is often a case where lumps of α-Fe is formed on the surface of the Sm—Fe—N particles. When such lumps of α-Fe are present on the surface of the particles, and a magnetic field is applied to the Sm—Fe—N magnet, the magnetization of the Sm—Fe—N particles is reversed, and as a result, the coercivity of the magnet is reduced.

Conversely, in the embodiment of the present disclosure, α-Fe is formed in a “layer manner” rather than in a lump. In a thin form such as the “layer”, it is considered that it is less likely to be the starting point of magnetization reversal than α-Fe in a lump form, and as a result, in the embodiment of the present disclosure, the reduction in the coercivity is alleviated in the produced magnet.

Furthermore, in the embodiment of the present disclosure, the second layer is formed to cover the first layer. It is also considered that the presence of the second layer alleviates the magnetization reversal by the first layer, thereby alleviating a reduction in the coercivity.

In addition, the second layer is expected to be effective in repairing damage to the surface of the particles. In other words, in a case where the surface of the particles is damaged or defective in the process of preparing Sm—Fe—N particles, such damage may adversely affect the magnetic properties of the produced magnets. However, in the embodiment of the present disclosure, the second layer coats the surface of the Sm—Fe—N particles, and therefore, it is considered that such damage is repaired and that an adverse effect on the magnetic properties caused by the damage to the surface is alleviated.

In any case, according to the embodiment of the present disclosure, a Sm—Fe—N magnet having a high coercivity by forming a coating layer is formed on the surface of a Sm—Fe—N particle and/or an interface between particles can be provided.

(Sm—Fe—N Magnet According to the Embodiment of the Present Disclosure)

Hereinafter, the embodiment of the present disclosure is explained in detail with reference to drawings.

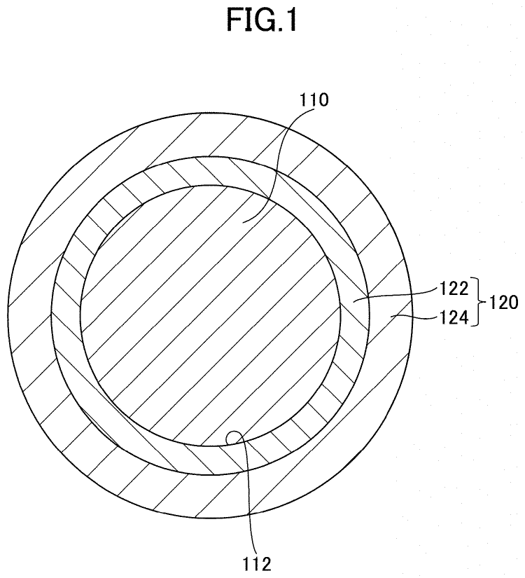

FIG. 1 is a drawing schematically illustrating an example of configuration of a cross section of Sm—Fe—N particle included in the Sm—Fe—N magnet according to the embodiment of the present disclosure.

The Sm—Fe—N magnet is produced by sintering Sm—Fe—N particles. Therefore, in practice, the Sm—Fe—N-particles are at least partially bonded to other Sm—Fe—N-particles in the Sm—Fe—N magnet.

Therefore, it should be noted that FIG. 1 is a hypothetical configuration of a single Sm—Fe—N particle, depicted for clarity of description.

As illustrated in FIG. 1, a Sm—Fe—N particle 110 included in the Sm—Fe—N magnet includes a surface 112. A coating layer 120 is provided on at least a portion of the surface 112.

The coating layer 120 includes a first layer 122 and a second layer 124, the first layer 122 being closer to the surface 112 of the Sm—Fe—N particles 110 than is the second layer 124.

The first layer 122 is composed of a phase mainly including α-Fe.

The second layer 124 is composed of a phase mainly including a Sm—Fe—Zn alloy. The amount of Zn contained in the second layer 124 is 1 at % to 20 at %, preferably 5 at % to 15 at %.

When the coating layer 120 is formed on the surface 112 of the Sm—Fe—N particle 110, the coercivity of the magnet can be improved.

In the example illustrated in FIG. 1, the coating layer 120 is provided on the entirety of the surface 112 of the Sm—Fe—N particle 110. However, as described above, the coating layer 120 may be provided on a portion of the surface 112 of the Sm—Fe—N particle 110.

For example, the coverage factor of the coating layer 120 to the surface 112 of the Sm—Fe—N particle 110 is 20% or more, preferably 40% or more, and more preferably 60% or more. Conversely, the coverage factor of the second layer 124 to the surface 112 of the Sm—Fe—N particle 110 or the surface of the first layer 122 is 50% or more, preferably 70% or more, and more preferably 90% or more.

This coverage factor is a coverage factor with respect to a portion excluding a bonding interface with other particles, i.e., with respect to an exposed surface, on the surface of the Sm—Fe—N particle 110 in a cross-sectional view. Furthermore, in the present application, the “coverage factor” is an average value of coverage factors measured for 20 particles.

Alternatively, as described above, the coating layer 120 may be formed on at least on a portion of the interface between two Sm—Fe—N particles 110 bonded with each other.

In this case, for example, the coating layer 120 is formed in an area of about 20% or more, preferably 40% or more, and more preferably 60% or more of the interface. The coverage factor of the second layer 124 to the surface 112 of the Sm—Fe—N particle 110 or the surface of the first layer 122 is 50% or more, preferably 70% or more, and more preferably 90% or more.

The Sm—Fe—N magnet having such a configuration has a significantly high coercivity as described above.

For example, the coercivity of the Sm—Fe—N magnet according to the embodiment of the present disclosure may be 25 kOe or more.

The Sm—Fe—N magnet according to the embodiment of the present disclosure may include zinc (Zn) at 1 wt % or more and 20 wt % or less. Furthermore, the Sm—Fe—N magnet according to the embodiment of the present disclosure preferably has oxygen at less than 1.0 wt % and more preferably less than 0.8 wt %.

(Details of each Portion)

Next, each portion included in the Sm—Fe—N magnet according to the embodiment of the present disclosure is explained in more detail.

(Sm—Fe—N Particle 110)

The Sm—Fe—N particle 110 is a particle containing Sm (samarium), Fe (iron), and N (nitrogen).

The Sm—Fe—N particle 110 may contain other additional elements. The additional element may be at least one selected from the group consisting of: for example, rare earth elements such as neodymium and praseodymium (excluding samarium); and cobalt.

The total content of the additional elements is preferably less than 30 at % in terms of the anisotropic magnetic field and magnetization.

The average particle diameter of the Sm—Fe—N particles 110 is preferably less than 2.0 μm. When the average particle diameter of the Sm—Fe—N particles 110 is less than 2.0 μm, the coercivity of the Sm—Fe—N magnet is further increased. The average particle diameter of the Sm—Fe—N particles 110 is preferably more than 0.1 μm. When the average particle diameter of the Sm—Fe—N particles 110 is 0.1 μm or less, it becomes difficult to suppress the oxidation of the Sm—Fe—N particles, and a different phase is likely to occur in the magnet according to the embodiment of the present disclosure.

In the magnet according to the embodiment of the present disclosure, the ratio of Sm—Fe—N particles 110 having an aspect ratio of 2.0 or more is preferably 10% or less, more preferably 8% or less. When the ratio of Sm—Fe—N particles 110 having an aspect ratio of 2.0 or more is 10% or less, the coercivity of the magnet according to the embodiment of the present disclosure is further increased.

The Sm—Fe—N particles 110 include oxygen at, for example, less than 1 wt %, and preferably less than 0.8 wt %. When the Sm—Fe—N particles 110 include oxygen at a higher ratio, the magnet according to the embodiment of the present disclosure is more likely to have a different phase.

(Coating Layer 120)

The coating layer 120 is provided on at least a portion of the surface 112 of the Sm—Fe—N particle 110. Alternatively, the coating layer 120 may be formed on at least on a portion of the interface between the Sm—Fe—N particles 110 bonded with each other.

In particular, the coating layer 120 is preferably provided on both of: the surface 112 of each of the Sm—Fe—N particles 110; and the interface between two Sm—Fe—N particles 110 bonded with each other.

The thickness of the coating layer 120 is, for example, in a range of 2 nm or more and 200 nm or less, and preferably in a range of 21 nm or more and 71 nm or less.

In the present application, the thickness of a layer means an average thickness of measurement results at 20 locations.

(First Layer 122)

The first layer 122 is composed of a phase mainly including α-Fe. In addition, the first layer 122 may include a small amount of Zn.

The thickness of the first layer is, for example, in a range of 1 nm or more and 100 nm or less and preferably in a range of 1 nm or more and 21 nm or less.

It should be noted that the first layer 122 does not necessarily have to be provided below the entirety of the area where the second layer 124 is provided. That is, there may be an area under the second layer 124 where the first layer 122 is not provided. However, such a portion is not referred to as the “coating layer 120” but is referred to simply as a provided area of the Sm—Fe—Zn alloy layer.

(Second Layer 124)

The second layer 124 is composed of a phase mainly including a Sm—Fe—Zn alloy. The amount of Zn contained in the second layer 124 is 1 at % to 20 at %, preferably 5 at % to 15 at %. The amount of Zn contained in the second layer 124 is in a range of 1 at % or more and 20 at % or less and preferably in a range of 5 at % or more and 15 at % or less.

The second layer 124 may further include elements such as oxygen, nitrogen, and carbon.

The crystal structure of the second layer 124 may be, but is not limited to, SmFe₂, SmFe₃, SmFe₅, Sm₂Fe₁₇, SmFe₇, or SmFe₁₂. Alternatively, the second layer 124 may be amorphous.

The thickness of the second layer is, for example, in a range of 1 nm or more and 100 nm or less, and preferably in a range of 20 nm or more and 50 nm or less.

(Method for Producing Sm—Fe—N Magnet According to Embodiment of the Present Disclosure)

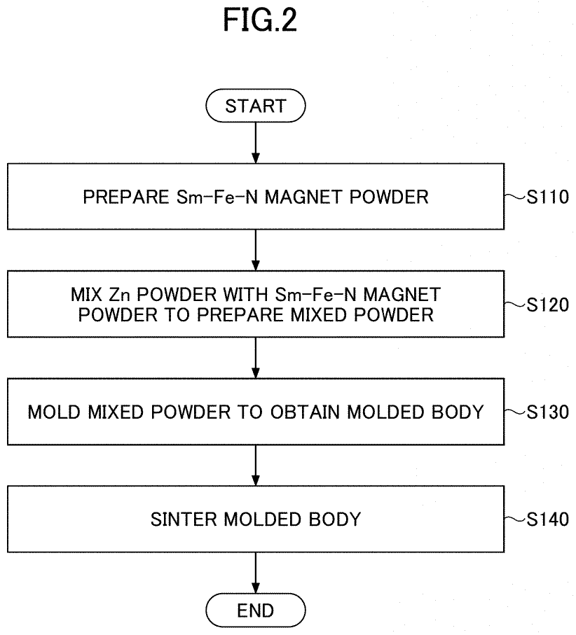

Next, a method for producing the Sm—Fe—N magnet according to the embodiment of the present disclosure is explained in more detail with reference to FIG. 2.

FIG. 2 schematically illustrates an example of a flow of a method for producing a Sm—Fe—N magnet (hereinafter referred to as a “first method”) according to the embodiment of the present disclosure.

As illustrated in FIG. 2, the first method includes:

preparing Sm—Fe—N magnet powder (step S110);

mixing Zn powder with the Sm—Fe—N magnet powder to prepare mixed powder (step S120);

molding the mixed powder to obtain a molded body (step S130); and

sintering the molded body (step S140).

Hereinafter, each step is explained.

(Step S110)

First, Sm—Fe—N magnet powder is prepared.

The method for producing the magnet powder is not particularly limited.

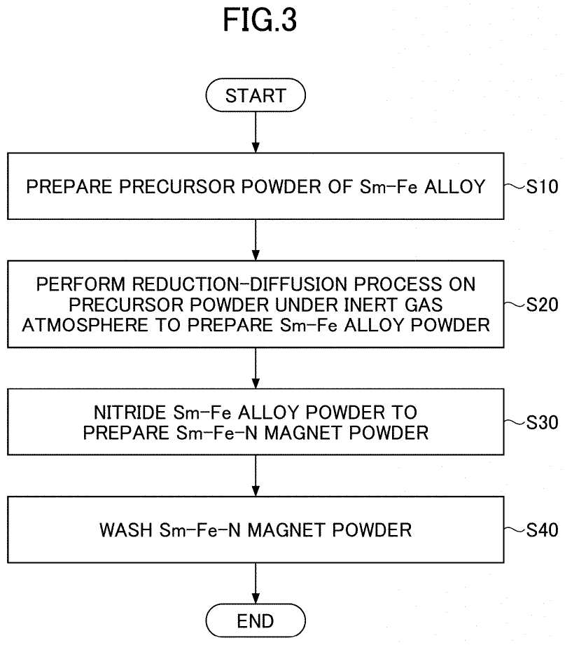

Hereinafter, an example of the method for producing the magnet powder is explained with reference to FIG. 3.

FIG. 3 schematically illustrates a flow of a method for producing Sm—Fe—N magnet powder.

As illustrated in FIG. 3, a method for producing the magnet powder includes:

preparing precursor powder of a Sm—Fe alloy (S10); performing a reduction-diffusion process on the precursor powder under an inert gas atmosphere to prepare Sm—Fe alloy powder (S20);

nitriding the Sm—Fe alloy powder to prepare Sm—Fe—N magnet powder (S30); and

washing the Sm—Fe—N magnet powder (S40).

Hereinafter, each step is briefly explained.

(Step S10)

First, a precursor powder of Sm—Fe alloy is prepared.

The precursor powder may be, for example, Sm—Fe oxide powder or Sm—Fe hydroxide powder. Hereinafter, the Sm—Fe oxide powder and the Sm—Fe hydroxide powder are collectively referred to as Sm—Fe hydrooxide powder.

The precursor powder may be prepared, for example, by a coprecipitation method. In this method, a precipitating agent such as an alkali is first added to a solution containing a samarium salt or an iron salt to cause precipitation, and then the precipitate is recovered by filtration, centrifugation, and the like. Then, the precipitate is washed and dried, and the precipitate is pulverized to obtain Sm—Fe hydrooxide powder.

When the Sm—Fe—N magnet powder contains metallic iron, the magnetic characteristic decreases. Therefore, when the precursor powder is produced, it is preferable to add samarium at an amount larger than the stoichiometric ratio.

The counter ion in the samarium salt and the iron salt may be an inorganic ion such as a chloride ion, a sulfate ion, a nitrate ion, or an organic ion such as an alkoxide.

Water may be used as the solvent contained in the solution containing the samarium salt and the iron salt, but an organic solvent such as ethanol may be used.

As the alkali, hydroxides of alkali metal and alkaline earth metal and ammonia can be used. A compound which decomposes by external action such as heat and acts as a precipitating agent, such as urea, may be used.

The obtained precursor powder may then be handled in an atmosphere shielded environment, such as a glovebox, until Sm—Fe—N magnet powder is produced. When an inert gas atmosphere is used, the oxygen concentration is preferably 1 ppm or less.

The obtained precursor powder is preferably pre-reduced in a reducing atmosphere. Thus, the amount of calcium used in a subsequent reduction-diffusion process step (step S20) decreases, and the generation of coarse Sm—Fe alloy particles can be alleviated.

The pre-reduction of the precursor powder may be performed, for example, by heating the precursor powder to 400° C. or higher in a hydrogen atmosphere. The treatment temperature is preferably in a range of 500° C. to 800° C. When the pre-reduction is performed in this temperature range, powder of Sm—Fe alloy with uniform particle diameter can be obtained.

(Step S20)

Next, the reduction-diffusion treatment is performed on the precursor powder in an inert gas atmosphere.

Examples of methods for performing the reduction-diffusion process include a method in which the precursor powder is mixed with calcium (Ca) or calcium hydride (CaH₂) and then heated to a temperature equal to or higher than the melting point of Ca (about 842° C.)

During this treatment, Sm reduced by Ca diffuses through the Ca melt and reacts with Fe to form Sm—Fe alloy powder.

There is a correlation between the temperature of the reduction-diffusion process and the particle diameter of the Sm—Fe alloy powder, and as the reduction-diffusion temperature increases, the particle diameter of the Sm—Fe alloy powder increases.

The average particle diameter of the Sm—Fe alloy powder is preferably less than 2.0 μm. When the average particle diameter of the Sm—Fe alloy powder is less than 2.0 μm, the coercivity of the magnet is further increased. Furthermore, the average particle diameter of the Sm—Fe alloy powder is preferably more than 0.1 μm and less than 2.0 μm.

In order to obtain Sm—Fe alloy powder having a uniform particle diameter, the reduction-diffusion treatment is performed on the precursor powder at 850° C. to 1050° C. for about 1 minute to 2 hours under an inert gas atmosphere.

With the progress of the reduction-diffusion process in the precursor, crystallization occurs to form Sm—Fe alloy powder. In addition, in the obtained Sm—Fe alloy powder, an Sm-rich phase is formed on at least a portion of the surface of each particle.

In the Sm—Fe alloy powder, the ratio of the number of particles having an aspect ratio of 2.0 or more is preferably 10% or less, and is more preferably 8% or less. When the ratio of the particles having an aspect ratio of 2.0 or more is 10% or less, the coercivity of the magnet powder is further increased.

The amount of residual oxygen in the Sm—Fe alloy powder obtained after step S20 is preferably less than 1.0 wt %. When the amount of residual oxygen of the Sm—Fe alloy powder is less than 1.0 wt %, the coercivity of the magnet is further increased.

(Step S30)

Next, the nitriding process is performed on the obtained Sm—Fe alloy powder.

Examples of methods for nitriding the Sm—Fe alloy powder include a method for heat-treating the Sm—Fe alloy powder at 300° C. to 500° C. in an atmosphere such as ammonia, a mixed gas of ammonia and hydrogen, nitrogen, or a mixed gas of nitrogen and hydrogen.

When ammonia is used, the Sm—Fe alloy powder can be nitrided in a short time. However, the amount of nitrogen in the Sm—Fe—N magnet powder may be higher than the optimum value. In this case, the Sm—Fe alloy powder is preferably nitrided and then annealed in hydrogen. Thus, excess nitrogen can be discharged from the crystal lattice.

The Sm—Fe—N magnet powder is famed by a nitriding process.

The composition of the particles contained in the Sm—Fe—N magnet powder is preferably Sm₂Fe₁₇N₃.

For example, the Sm—Fe alloy powder is heat-treated at 350° C. to 450° C. for 10 minutes to 2 hours under an ammonia-hydrogen mixed atmosphere, and then annealed at 350° C. to 450° C. for 30 minutes to 2 hours under a hydrogen atmosphere. Thus, the amount of nitrogen in the Sm—Fe—N magnet powder can be optimized.

(Step S40)

Next, the Sm—Fe—N magnet powder formed in step S30 is washed.

The Sm—Fe—N magnet powder foamed in step S30 contains a calcium compound. A washing treatment is performed to remove the calcium compound.

The washing treatment is performed using, for example, a washing liquid such as water or alcohol, or both. Alternatively, the washing solution may be an acid such as amidosulfuric acid. Alternatively, the Sm—Fe—N magnet powder may be washed with water or alcohol, or both, and then washed with amidosulfuric acid. The temperature of the washing liquid is not particularly limited, but it is preferable to select a temperature at which the solubility of CaO and Ca(OH)₂ is high. For example, in a case where the washing liquid is water, the washing liquid is preferably at 0° C. to room temperature.

The washing step may be performed before the nitriding treatment.

The washed Sm—Fe—N magnet powder is preferably dried thereafter.

The drying temperature is not particularly limited, but the drying temperature is preferably room temperature to 100° C. The oxidation of the Sm—Fe—N magnet powder can be alleviated by setting the drying temperature to 100° C. or less.

Furthermore, a dehydrogenation process may be performed on the Sm—Fe—N magnet powder. Hydrogen that has entered the crystal lattice during the washing treatment can be removed by the dehydrogenation process.

The method of the dehydrogenation process is not particularly limited. For example, dehydrogenation may be performed by heating the Sm—Fe—N magnet powder under vacuum or in an inert gas atmosphere. For example, a dehydrogenation process may be performed on the Sm—Fe—N magnet powder through the heat treatment at 150° C. to 250° C. for 1 hour in a vacuum atmosphere.

According to the above steps, the Sm—Fe—N magnet powder can be produced. The amount of residual oxygen in the magnet powder is less than 1.0 wt %.

The average particle diameter of the obtained Sm—Fe—N magnet powder is preferably more than 0.1 μm and less than 2.0 μm.

The amount of residual oxygen is preferably less than 1.0 wt %, and is more preferably less than 0.8 wt %.

(Step S120)

Next, Zn powder is mixed with the Sm—Fe—N magnet powder produced by the above-described method to prepare mixed powder.

The average particle diameter of the Zn powder is in a range of, for example, 5 μm to 100 μm. In particular, the average particle diameter of the Zn powder is preferably larger than that of the Sm—Fe—N magnet powder.

The mixing amount of the Zn powder is not particularly limited, but may be, for example, 1 wt % or more and 20 wt % or less with respect to the entirety of the mixed powder.

Although the method of mixing the Sm—Fe—N magnet powder and the Zn powder is not particularly limited, it is preferable to mix the Sm—Fe—N magnet powder so as not to cause physical damage to the surface of each particle of the Sm—Fe—N magnet powder. For example, it is preferable to avoid methods such as mixing by a ball-mill and crushing.

(Step S130)

Next, the mixed powder is molded to produce a molded body.

The molding is preferably performed under an environment where a magnetic field, such as a static magnetic field, is applied. When molding is performed under the static magnetic field, a molded body in which the easy axis of magnetization of particles is oriented along the static magnetic field can be obtained, and an anisotropic magnet can be obtained after sintering.

For example, a molded body is obtained by pressurizing the mixed powder with a mold while applying a static magnetic field to the mixed powder in the mold.

The pressure applied by the mold to the mixed powder may be, for example, 10 MPa or more and 3000 MPa or less. In order to uniformly diffuse Zn, the pressure is preferably 500 MPa or less.

The strength of the magnetic field applied to the mixed powder may be 5 kOe or more and 40 kOe or less.

(Step S140)

Next, the sintering process is performed on the molded body.

The Zn powder contained in the molded body is melted by the sintering process. The molten Zn is spread throughout the Sm—Fe—N magnet powder during the sintering process, and eventually a coating layer as described above can be formed.

The sintering process may be performed, for example, by a spark plasma sintering method, a hot press method, or a electric-current pressure sintering. Among these, the electric-current pressure sintering which can achieve low heat load sintering by high-speed heating and short-time sintering is preferable.

The sintering conditions may be appropriately set in accordance with the composition of the magnet to be produced and the average particle diameter of the powder contained therein.

The sintering process may include a temperature raising process and a temperature holding process subsequent to the temperature raising process, or may include only the temperature raising process.

The reaching temperature in the temperature raising process may be, for example, 420° C. or more and 600° C. or less.

The heating rate in the heating process may be, for example, 5° C./min or more and 100° C./min or less.

The sintering time in the temperature holding process may be, for example, 5 hours or less, and may be 0 hours.

The method of heating the molded body is not particularly limited. The molded body may be sintered by resistance heating, electrical heating, or radio frequency heating.

The atmosphere of the sintering process is, for example, a nitrogen atmosphere, an argon atmosphere, or a vacuum (reduced pressure atmosphere). The oxygen concentration and the water concentration in the atmosphere are preferably 1 ppm or less, and preferably 0.5 ppm or less, respectively. These concentrations are in mole fractions.

The sintered body may be cooled after the sintering process. The cooling rate of the sintered body may be, for example, 5° C./min or more and 100° C./min or less.

The Sm—Fe—N magnet having the above-described characteristics can be produced by the above process.

### EXAMPLES

Hereinafter, examples of the present disclosure is explained. In the following explanation, Examples 1 to 3 are examples of the present embodiment and Examples 11 to 13 are comparative examples.

### Example 1

The Sm—Fe—N magnet was produced according to the following method.

(Preparation of Mixed Powder)

First, mixed powder was prepared according to the following method.

(Preparation of Sm—Fe-hydrooxide Powder)

After 64.64 g of iron nitrate enneahydrate and 12.93 g of samarium nitrate hexahydrate were dissolved in 800 ml of water, 120 ml of a potassium hydroxide aqueous solution at a concentration of 2 mol/L was added dropwise while stirring, and the mixture was stirred overnight at room temperature to prepare a suspension. The suspension was then filtered, the filtrate was washed, and thereafter, dried overnight at 120° C. in an air atmosphere using a hot air oven. Next, the filtrate was coarsely ground by a blade mill and then finely ground in ethanol by a rotary mill using a stainless steel ball. Then, the filtrate pulverized in ethanol was centrifuged and dried in vacuum to prepare Sm—Fe-hydrooxide powder.

(Pre-Reduction)

Sm—Fe-hydrooxide powder was pre-reduced by a heat process at 600° C. for 6 hours under a hydrogen atmosphere to prepare powder (referred to as powder D).

(Reduction-Diffusion Process)

5.0 g of powder A and 2.5 g of calcium powder were put into an iron crucible, and the mixture was heated and kept at 900° C. for 1 hour to perform a reduction-diffusion process to prepare powder (referred to as powder B).

(Nitriding)

After the powder B was cooled to normal temperature, the temperature was raised to 380° C. under a hydrogen atmosphere. Next, the powder B was nitrided by raising the temperature to and kept at 420° C. for 1 hour in an ammonia-hydrogen mixed atmosphere with a volume ratio of 1:2.

Next, after the powder B was annealed at 420° C. for 1 hour under a hydrogen atmosphere, the powder B is annealed at 420° C. for 0.5 hours under an argon atmosphere to optimize the amount of nitrogen in the powder B. Thus, powder C was obtained.

(Washing)

The powder C was washed five times with pure water. The powder C having been washed and an aqueous solution of amidosulfuric acid were added and kept at pH 5 for 15 minutes to remove the calcium compound. Next, the powder C was washed with pure water to remove the amidosulfuric acid. Thus, powder D was obtained.

(Vacuum Drying)

The water remaining in the powder D was replaced with 2-propanol, and then dried in vacuum at room temperature.

The powder D having been dried in vacuum was dehydrated at 200° C. for 3 hours under vacuum.

The steps of the pre-reduction and subsequent steps were performed in the glovebox in an argon atmosphere without being exposed to the atmosphere.

The Sm—Fe—N magnet powder (hereinafter referred to as “powder E”) was obtained as a result of performing the above-described steps.

(Evaluation of Powder E)

At this stage, various evaluations of the obtained powder E were performed.

(Evaluation of Coercivity)

The coercivity of the powder E was measured using the following method.

First, the powder E and a thermoplastic resin were mixed and then magnetized in a magnetic field of 20 kOe to prepare a sample for powder coercivity measurement. Next, the sample for powder coercivity measurement was measured with a vibrating sample magnetometer (VSM). The measurement temperature was 27° C., and the maximum applied magnetic field was 90 kOe.

As a result of the measurement, the coercivity of the sample for powder coercivity measurement was 32.2 kOe.

(Measurement of Average Particle Diameter)

The powder E was mixed with a thermosetting epoxy resin, thermally cured, and then irradiated with a focused ion beam (FIB) to perform etching, thereby exposing a cross section and preparing a sample.

A field emission scanning electron microscope (FE-SEM) was used to observe the cross-sections of the samples and contour more than 200 randomly selected particles.

The contour lines correspond to the surfaces of particles and/or the surfaces of particles in contact therewith. However, the particles in contact therewith can be distinguished by a FE-SEM backscatteredelectron image or by energy dispersive X-ray spectroscopy (EDS) mapping.

The diameter of a circle having the same area as the area surrounded by the contour line is defined as a particle diameter of the particle. The average particle diameter of the powder E was determined by calculating a volume-weighted average of the particle diameters of the particles.

The average particle diameter of the powder E was 1.4 μm.

(Preparation of Mixed Powder)

Next, the powder E (i.e., the Sm—Fe—N magnet powder) and Zn powder were slowly mixed by a V type blender to prepare a mixed powder.

The amount of Zn powder added was 5 wt % with respect to the entirety of the mixed powder. The average particle diameter of the Zn powder was 6 μm to 9 μm.

The prepared mixed powder is referred to as “mixed powder 1”.

(Preparation of Magnet)

Next, according to the following method, the mixed powder 1 was molded, and the obtained molded body was sintered to produce a magnet.

The molding pressure was 200 MPa.

The sintering temperature of the molded body was 470° C., and the sintering time was 1 minute.

Thus, a sintered magnet was obtained. The obtained sintered magnet is referred to as a “magnet 1”.

### Example 2

A sintered magnet was produced by substantially the same method as the method of the Example 1. However, in the Example 2, the amount of Zn powder added to the mixed powder was 10 wt %. Other production conditions are the same as production conditions of the Example 1.

The obtained sintered magnet is referred to as a “magnet 2”.

### Example 3

A sintered magnet was produced by substantially the same method as the method of the Example 1. However, in the Example 3, the amount of Zn powder added to the mixed powder was 20 wt %. Other production conditions are the same as production conditions of the Example 1.

The obtained sintered magnet is referred to as a “magnet 3”.

### Example 11

A sintered magnet was produced by substantially the same method as the method of the Example 1. However, in the Example 11, Zn powder was not added to the powder E, i.e., the powder E was molded and sintered to produce a magnet, without Zn powder.

The obtained sintered magnet is referred to as a “magnet 11”.

### Example 12

A sintered magnet was produced by substantially the same method as the method of the Example 2. However, in the Example 12, when preparing the mixed powder, the powder E and Zn powder were dispersed and mixed using a ball mill. Other production conditions are the same as production conditions of the Example 2.

The obtained sintered magnet is referred to as a “magnet 12”.

### Example 13

A sintered magnet was produced by substantially the same method as the method of the Example 2. However, in the Example 13, when preparing the mixed powder, the powder E and Zn powder were dispersed and mixed using a ball mill. Other production conditions are the same as production conditions of the Example 2. Furthermore, Zn powder with an average particle diameter of 1 μm was used. Other production conditions are the same as production conditions of the Example 2.

The obtained sintered magnet is referred to as a “magnet 13”.

Table 1 below summarizes the production conditions of the magnets.

TABLE 1

| | | Zn powder | | | | |
|---|---|---|---|---|---|---|
| | | | Average | | | |
| | Coercivity | | particle | Amount | Molding | Sintering |
| | of powder E | | diameter | added | pressure | temperature |
| Magnet | (kOe) | Mixing method | (μm) | (wt %) | (MPa) | (° C.) |
| 1 | 32.2 | V type blender | 6 to 9 | 5 | 200 | 470 |
| 2 | 32.2 | V type blender | 6 to 9 | 10 | 200 | 470 |
| 3 | 32.2 | V type blender | 6 to 9 | 20 | 200 | 470 |
| 11 | 32.2 | — | — | — | 200 | 470 |
| 12 | 32.2 | Dispersion by | 6 to 9 | 10 | 200 | 470 |
| | | ball milling | | | | |
| 13 | 32.2 | Dispersion by | 1 | 10 | 200 | 470 |
| | | ball milling | | | | |

(Evaluation)

The following evaluation was performed with respect to each produced magnet.

(Shape Evaluation of Sm—Fe—N System Particles)

The average particle diameter of the Sm—Fe—N particles contained in each magnet was measured. The aspect ratio of the Sm—Fe—N particles was also evaluated.

The average particle diameter of the Sm—Fe—N particle was measured by substantially the same method as the method for measuring the average particle diameter of the powder E explained above.

Furthermore, the aspect ratio was evaluated as follows.

For each particle, a quadrilateral circumscribing the contour and minimizing the area was determined. The aspect ratio of each particle was calculated by dividing the length of the long side by the length of the short side of the obtained quadrilateral. Furthermore, the ratio of particles of which the aspect ratios are 2 or more was determined.

(Evaluation of Coating Layer)

With respect to each magnet, the surfaces and interfaces of Sm—Fe—N particles were observed.

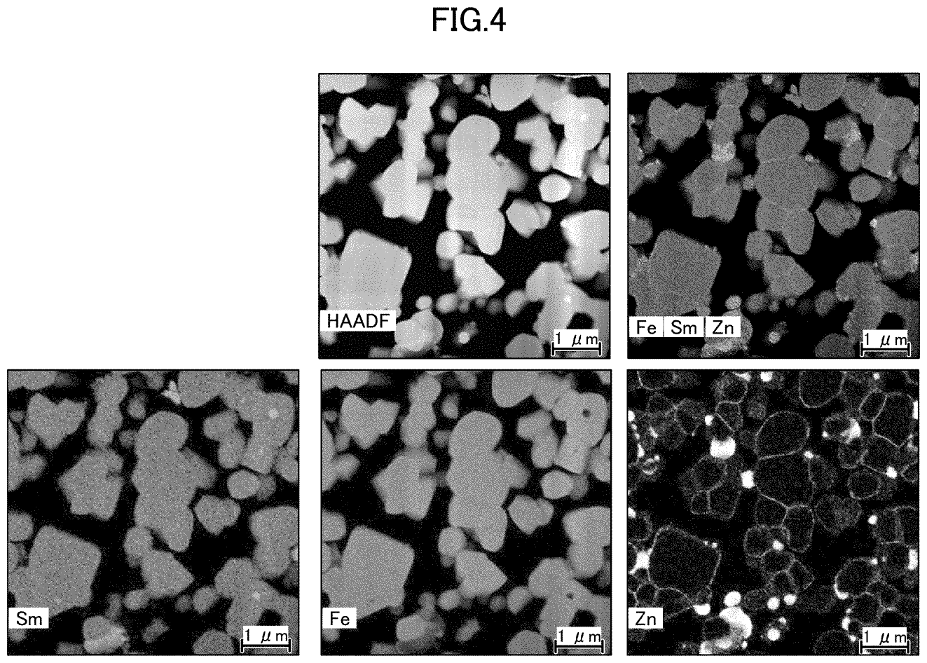

FIG. 4 is a drawing illustrating a mapping result of each element obtained by HAADF-STEM (High-angle Annular Dark Field Scanning Transmission Electron Microscopy) and EDS (Energy Dispersive X-ray Spectrometry) in a cross section of the magnet 2.

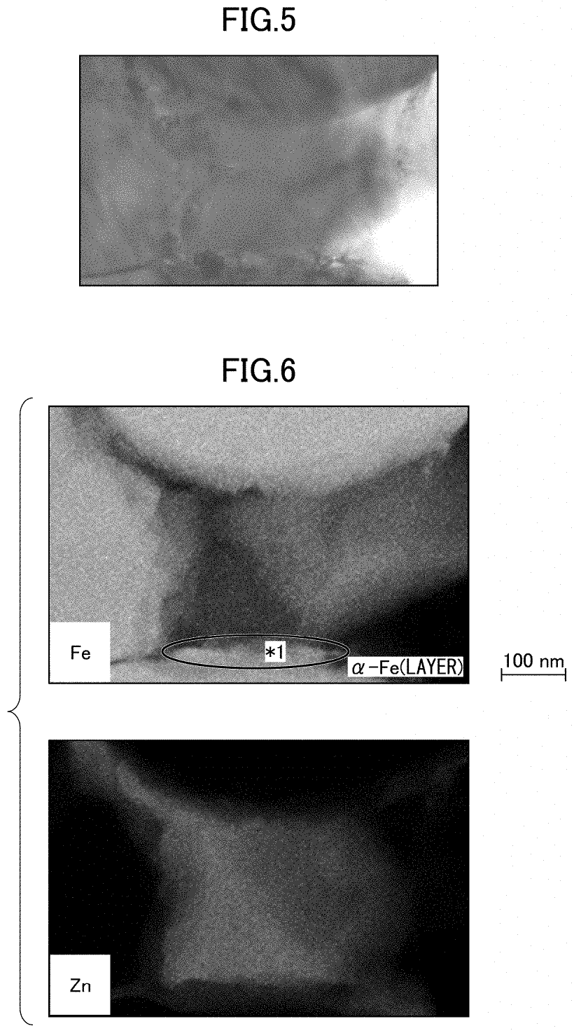

Furthermore, FIG. 5 is a drawing illustrating a TEM image (bright-field image) of an enlarged portion of an interface between Sm—Fe—N particles. In FIG. 5, for example, a Sm—Fe—N particle is present on each of the lower side, the left side, and the upper side.

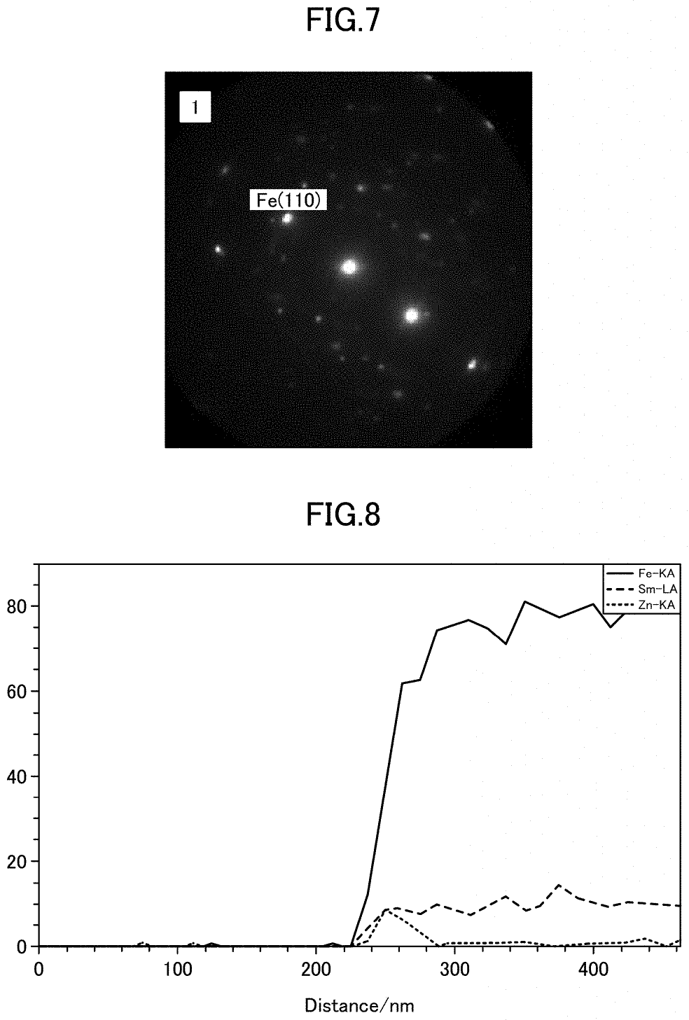

FIG. 6 is a drawing illustrating a mapping result of Fe and Zn obtained by EDS of an enlarged portion of an interface between Sm—Fe—N particles. In FIG. 6, for example, an Fe-rich layer is found in a portion surrounded by a circle. FIG. 7 is a drawing illustrating an electron diffraction image of an Fe-rich layer in an enlarged portion of an interface between Sm—Fe—N particles. In FIG. 6, a portion indicated by a mark “*1” corresponds to the diffraction image “(1)” in FIG. 7. Furthermore, from the comparison between FIGS. 7 and 6, it is understood that the portion indicated by the mark “*1” in FIG. 6 is an α-Fe layer.

It can be seen from FIG. 4 that Zn is present on the surfaces and the interfaces of the Sm—Fe—N particles. FIG. 6 indicates that an Fe-rich layer (first layer) is present on the surface of each of the Sm—Fe—N particles, and a Zn-containing layer (second layer) is present on the outside of the Fe-rich layer.

FIG. 8 is a drawing illustrating an example of an EDS line analysis result of an interface between Sm—Fe—N particles. In FIG. 8, the position where the distance along the horizontal axis is about 230 nm corresponds to the surface of a given particle, and an area where the distance is about 230 nm to about 290 nm corresponds to the coating layer.

In FIG. 8, although it is difficult to confirm the α-Fe layer in the coating layer due to the relation of magnification, it is recognized that a layer containing Sm, Fe and Zn (second layer) is present. From this result, it is assumed that the thickness of the second layer is about 50 nm.

(Evaluation of First Layer)

Interfaces between Sm—Fe—N particles were selected at 20 locations, and the thickness of the first layer (α-Fe phase) was measured with respect to each of the interfaces. The average thickness of the first layer was derived by averaging these measurement results.

(Evaluation of Second Layer)

Interfaces between Sm—Fe—N particles were selected at 20 locations, and the thickness of the second layer (Sm—Fe—Zn phase) was measured with respect to each of the interfaces. The average thickness of the second layer was derived by averaging these measurement results.

Furthermore, interfaces between Sm—Fe—N particles were selected at 20 locations, and the amount of Zn contained in the second layer was derived by EDS. The average value of the amount of Zn contained in the second layer was derived by averaging these measurement results.

(Measurement of the Amount of Zn in Magnet)

The amount of Zn contained in the entirety of the magnet was evaluated by inductively coupled plasma atomic emission spectroscopy (ICP-AES).

(Measurement of the Amount of Residual Oxygen in Magnet)

With respect to each magnet, the amount of residual oxygen was determined by inert gas fusion-nondispersive infrared absorption.

(Evaluation of Coercivity)

The coercivity of the magnet was measured with a vibrating sample magnetometer (VSM). The measurement temperature was 27° C., and the maximum applied magnetic field was 90 kOe.

Table 2 below summarizes the evaluation results of the magnets.

TABLE 2

| | Sm—Fe—N particles | | | | | | | |
|---|---|---|---|---|---|---|---|---|
| | | Ratio of | | | | | | |
| | | particles | | | | | | |
| | | of which | First | Second layer | | | | |
| | Average | aspect | layer | Average | | | Oxygen | |
| | particle | ratios are | Average | Zn | Average | Zn content | content | |
| | diameter | 2.0 or more | thickness | content | thickness | in magnet | in Magnet | Coercivity |
| Magnet | (μm) | (%) | (nm) | (at %) | (nm) | (wt %) | (wt %) | (kOe) |
| 1 | 1.4 | 6.0 | 21 | 8.3 | 34 | 5 | 0.7 | 32.7 |
| 2 | 1.4 | 6.0 | 9 | 10.9 | 39 | 10 | 0.7 | 44.5 |
| 3 | 1.4 | 6.0 | 18 | 15.3 | 40 | 20 | 0.7 | 34.3 |
| 11 | 1.4 | 6.0 | — | — | — | 0 | 0.7 | 13.8 |
| 12 | 1.2 | 12.0 | 25 | 20.3 | 32 | 10 | 0.8 | 23.4 |
| 13 | 1.1 | 12.0 | 32 | 23.8 | 37 | 10 | 0.8 | 17.1 |

As indicated in Table 2, it was found that the first layer and the second layer were famed in each of the magnets 1 to 3. The Zn content contained in the second layer was 20 at % or less.

Conversely, in the magnet 11, Zn powder was not added to the raw material, and therefore, the second layer was not formed, and only the first layer was observed. Further, although the first layer and the second layer were observed in the magnets 12 and 13, the Zn content in the second layer was found to exceed 20 at %.

Furthermore, it was also found that the coercivities of the magnets 11 to 13 were lower than the coercivity of the powder E in the raw material stage.

In contrast, it was found that the coercivities of the magnets 1 to 3 were higher than the coercivity of the powder E in the raw material stage.

In this manner, it was confirmed that the magnets 1 to 3 have significantly higher coercivities.

According to the present disclosure, a Sm—Fe—N magnet having a high coercivity comparable to the coercivity of Sm—Fe—N-powder can be provided.

The preferred embodiment of the present disclosure has been described above in detail. However, the present disclosure is not limited to the embodiment described above. Various modifications and substitutions can be applied to the above-described embodiment without departing from the scope of the present disclosure. Each of the features described with reference to the above-described embodiment may be appropriately combined unless such combination is technically contradictory.

What is claimed is:

1. A Sm—Fe—N magnet comprising:
Sm—Fe—N particles each having a surface, a coating layer being provided on at least a portion of the surface or on at least a portion of an interface between at least two of the Sm—Fe—N particles, or being provided on both,
wherein the coating layer includes a first layer and a second layer, the first layer being situated closer to the surface or the interface than is the second layer,
the first layer includes α-Fe,
the second layer includes a Sm—Fe—Zn alloy, and
a Zn content contained in the second layer is 1 at % or more and 20 at % or less.

2. The Sm—Fe—N magnet according to claim 1, wherein the Zn content contained in the second layer is 5 at % or more and 15 at % or less.

3. The Sm—Fe—N magnet according to claim 1, wherein an average particle diameter of the Sm—Fe—N particles is less than 2.0 μm, and a ratio of the Sm—Fe—N particles having an aspect ratio of 2.0 or more is 10% or less.

4. The Sm—Fe—N magnet according to claim 1, wherein an average thickness of the second layer is 1 nm or more and 100 nm or less.

5. The Sm—Fe—N magnet according to claim 1, wherein the Sm—Fe—N magnet includes Zn at 1 wt % or more and 20 wt % or less.

6. The Sm—Fe—N magnet according to claim 1, wherein the Sm—Fe—N magnet includes oxygen at less than 1.0 wt %.
